(19) United States
(12) Patent Application Publication
(10) Pub. No.: US 2011/0237302 A1
(43) Pub. Date: Sep. 29, 2011

(54) PORTABLE DEVICE

(75) Inventors: Nobuhiko Onda, Kawasaki (JP); Kazunori Murayama, Kawasaki (JP)

(73) Assignee: FUJITSU LIMITED, Kawasaki (JP)

(21) Appl. No.: 13/038,752

(22) Filed: Mar. 2, 2011

(30) Foreign Application Priority Data
Mar. 29, 2010 (JP) 2010-075935

(51) Int. Cl. H04M 1/02

(52) U.S. Cl. 455/566

(57) ABSTRACT

A portable device includes: a body unit which includes an operation surface on which a plurality of operation keys are provided; a display unit which includes a display surface on which an image display element is provided; a pair of substantially U-shaped slide rails which are fixed to a back surface of the display unit which is opposite to the display surface; and a slide guide which is fixed to the operation surface of the body unit and slidably engages with the pair of substantially U-shaped slide rails.

### CROSS-REFERENCE TO RELATED APPLICATIONS

This application is based upon and claims the benefit of priority of the prior Japanese Patent Application No. 2010-075935, filed on Mar. 29, 2010, the entire contents of which are incorporated herein by reference.

### FIELD

The invention generally relates to a portable device.

### BACKGROUND

In some portable devices, a display unit slides relative to a body unit. As illustrated in FIG. 11, there is a portable device (e.g., a mobile phone) in which an operation key part 46 (e.g., a numeric keypad and function keys) of a body unit 45 is exposed when a display unit 40 is slid in the longitudinal direction of the portable device. In addition, as illustrated in FIG. 12, there is also a portable device (a smartphone) in which an operation key part 46 (e.g., a QWERTY keyboard and functions keys) of a body unit 45 is exposed when a display unit 40 is slid in the lateral direction of the portable device.

Further, as illustrated in FIG. 13, there is also a portable device which allows a display unit 40 to slide in the lateral direction of the portable device and also allows the display unit 40 to slide in the longitudinal direction of the portable device.

In the structure in which the display unit 40 slides in two directions as illustrated in FIG. 13, the operability is far better than that in the structure in which the display unit 40 slides in only one direction as illustrated in FIGS. 11 and 12.

However, in order to allow the display unit 40 to slide in two directions, the portable device illustrated in FIG. 13 uses a slide mechanism which includes, as main components, a slider 51 mounted to an upper surface of the body unit 40, a slider 52 mounted to a back surface of the display unit 45, and base members 53 which slidably engage the sliders 51 and 52.

In other words, the portable device illustrated in FIG. 13 uses a slide mechanism in which general slide mechanisms, each allowing a member to slide relative to another member in only one direction, are caused to share components and stacked on each other. Such a slide mechanism is thicker than a general slide mechanism (the thickness is about double that of the general slide mechanism).

Moreover, in the portable device illustrated in FIG. 13, only a state where the display unit 40 is slid in the lateral direction (FIG. 13B) and a state where the display unit 40 is slid in the longitudinal direction (FIG. 13C) are assumed. Thus, depending on a state of being slid, some of keys on the body unit 45 cannot be operated (covered with the display unit 40).

As related arts, there are the following documents: Japanese Unexamined Patent Application Publication No. 2008-42265; Japanese Unexamined Patent Application Publication No. 7-238927; Japanese Unexamined Patent Application Publication No. 2008-34967; and Japanese Unexamined Patent Application Publication No. 2009-19767.

### SUMMARY

According to an aspect of the invention, a portable device includes: a body unit which includes an operation surface on which a plurality of operation keys are provided; a display unit which includes a display surface on which an image display element is provided; a pair of substantially U-shaped slide rails which are fixed to a back surface of the display unit which is opposite to the display surface; and a slide guide which is fixed to the operation surface of the body unit and slidably engages with the pair of substantially U-shaped slide rails.

The object and advantages of the invention will be realized and attained by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates a basic structure and functions of a portable device;

FIG. 2 is an exploded perspective view of the portable device in a mode A;

FIG. 3 is an exploded perspective view of the portable device in a mode B;

FIG. 4 is an exploded perspective view of the portable device in a mode C;

FIG. 5 is an exploded perspective view of the portable device in a mode D;

FIG. 6 is a longitudinal cross-sectional view of the portable device;

FIG. 7 is a lateral cross-sectional view of the portable device;

FIG. 8 is a perspective view of a torsion spring assembly;

FIG. 9 is a view illustrating a shape of an outer slide rail;

FIG. 10 is a view illustrating a shape of an inner slide rail;

FIGS. 11A and 11B illustrate a portable device in which a display unit slides;

FIGS. 12A and 12B illustrate a portable device in which a display unit slides;

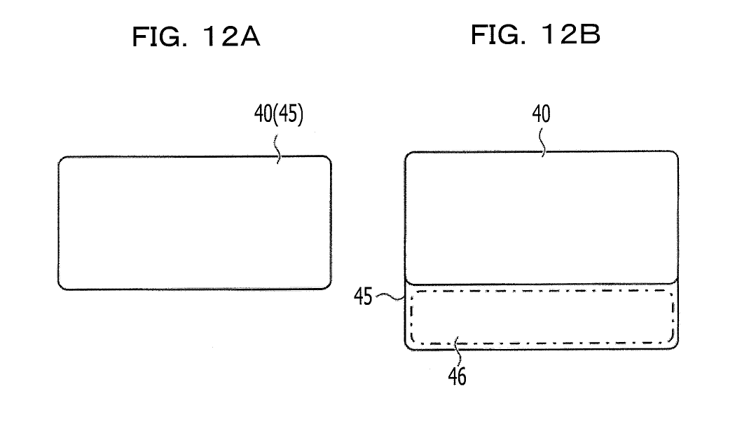

FIGS. 13A to 13C illustrate a portable device in which a display unit slides in two directions.

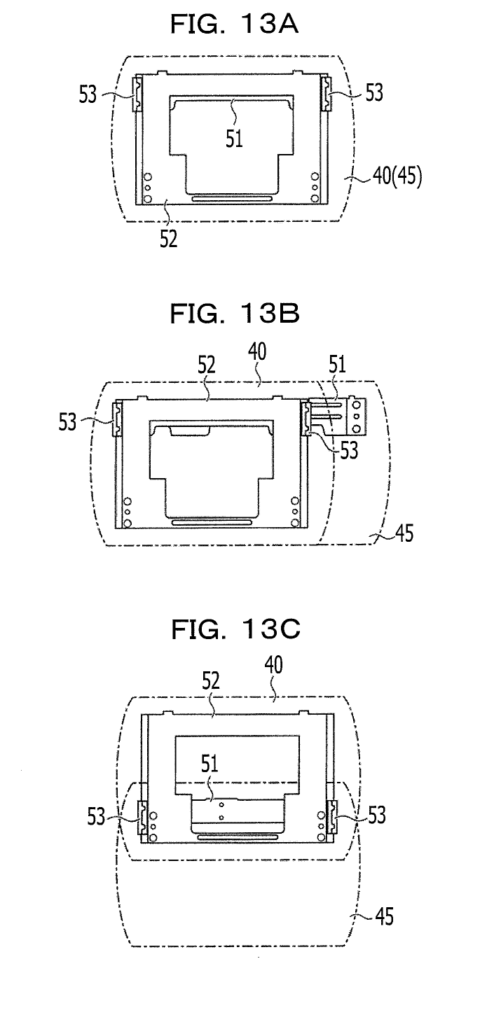

### DESCRIPTION OF EMBODIMENTS

Hereinafter, an example of a portable device developed by the inventors will be described in reference to the drawings.

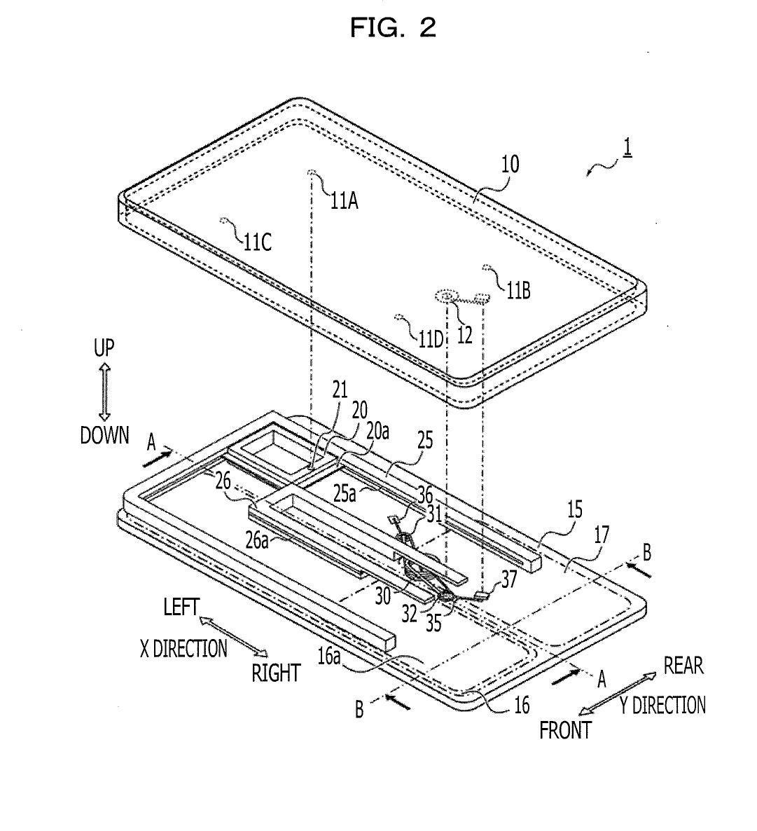

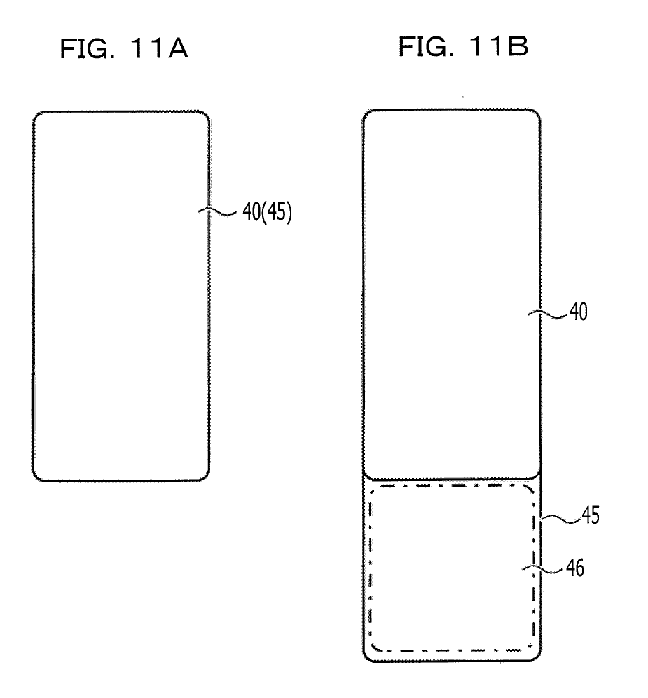

In reference to FIG. 11, a basic structure and functions of a portable device 1 according to an embodiment will be described. In the following description, a thickness direction of the portable device 1 is indicated as an up-down direction (a display unit 10 side is an upper side; see FIG. 2). In addition, a lateral direction of the portable device 1 is indicated as a front-rear direction (a full keyboard part 16 side is a front side) or a Y-direction, and a longitudinal direction of the portable device 1 is indicated as a right-left direction (a ten keypad part 16a and function key part 17 side is a right side) or an X-direction.

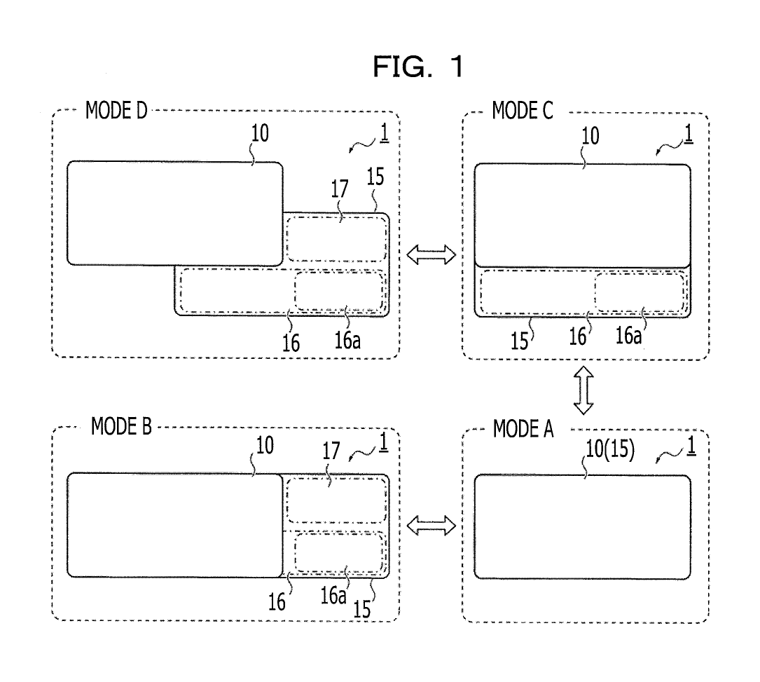

As schematically illustrated in FIG. 1, the portable device 1 according to the embodiment is a device, which includes a display unit 10 and a body unit 15 and in which the display unit 10 slides relative to the body unit 15.

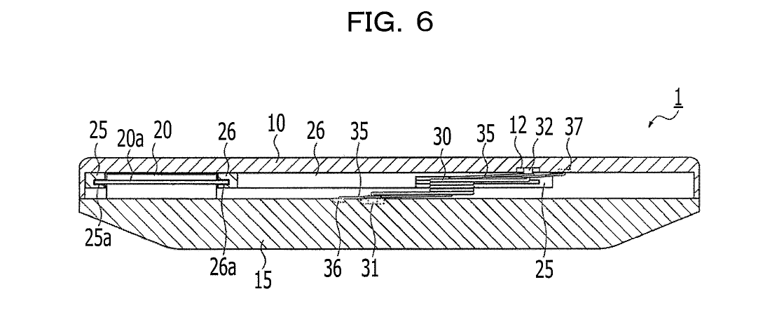

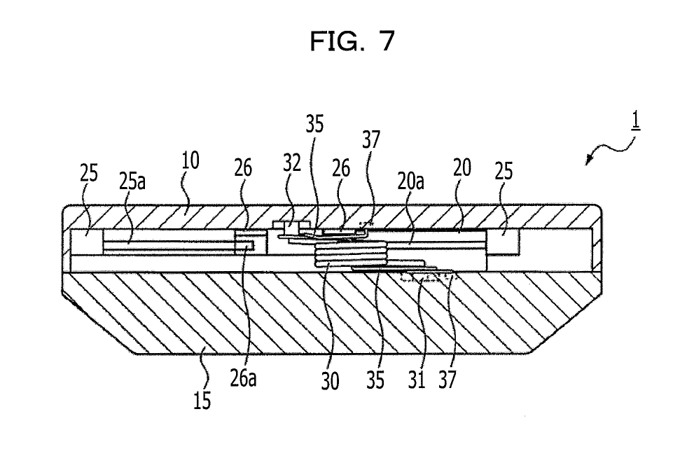

The display unit 10 is a unit in which a liquid crystal display (not illustrated) is provided on its upper surface (hereinafter, indicated as a display surface). The display unit 10 is a unit in which, similarly to a display unit of a general slide-type portable device, the liquid crystal display or the like are accommodated in a housing which is composed of a plurality of members. Note that the display unit 10 is not a box-like (convex polyhedron-like) unit, but a unit having a shape (see FIGS. 6 and 7) in which a peripheral wall is mounted under the outer periphery of a box-like member.

The body unit 15 is a unit which accommodates a CPU or the like in a housing and performs various processes (e.g., a process of displaying an image on the liquid crystal display of the display unit 10, or the like). On an upper surface (hereinafter, indicated as an operation surface) of the body unit 15, a full key part 16 including a ten keypad part 16a, and a function key part 17, are provided.

Here, the ten keypad part 16a is a part in which a plurality of keys (key switches) for inputting numbers or the like are arranged. In addition, the full key part 16 is a part which is composed of the ten keypad part 16a and a part in which a plurality of keys for inputting alphabets or the like are arranged.

The function key part 17 is a part in which a plurality of function keys are provided.

As illustrated, the full key part 16 of the portable device 1 (body unit 15) has the ten keypad part 16a and has such a size as to substantially cover a front half area of the operation surface. In addition, the function key part 17 has such a size as to substantially cover a right half of the remaining area of the operation surface.

Between the display unit 10 and the body unit 15, a slide mechanism (not illustrated) is provided. The portable device 1 according to this embodiment uses, for its slide mechanism, a mechanism with a single-layer structure, which allows the portable device 1 to be in the following modes A to D (see FIG. 1):

mode A in which the display unit 10 covers the body unit 15;

mode B in which the display unit 10 is slid to the left side of the body unit 15 (mode B in which the ten keypad part 16a and the function key part 17 are exposed);

mode C in which the display unit 10 is slid to the rear side (the upper side in FIG. 1) of the body unit 15 (mode C in which the full key part 16 is exposed); and

mode D in which the display unit 10 is slid to the rear-left side of the body unit 15 (mode D in which the full key part 16 and the function key part 17 are exposed).

Based on the above assumptions, the structure of the portable device 1 will be described more specifically below.

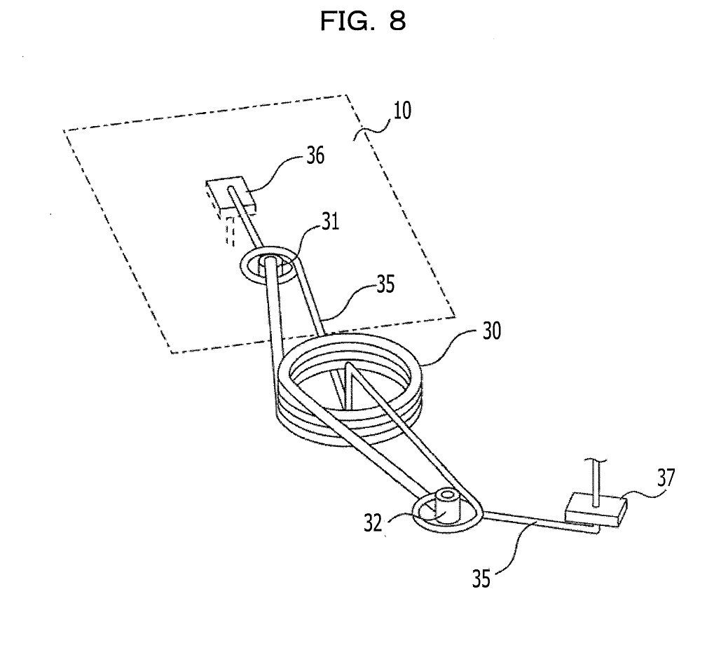

FIGS. 2 to 5 are exploded perspective views of the portable device 1 in the modes A to D, respectively. FIGS. 6 and 7 are longitudinal and lateral cross-sectional views, respectively, of the portable device 1. In addition, FIG. 8 is an enlarged view of a part (hereinafter, indicated as torsion spring assembly) of the portable device 1, which includes a torsion spring 30, a cable 35, or the like. It is noted that each exploded perspective view shows an appearance of the portable device 1 in the case where the display unit 10 is removed and moved directly above its original position. The longitudinal cross-sectional view (FIG. 6) corresponds to a cross-sectional view taken along the line A-A in FIG. 2, and the lateral cross-sectional view (FIG. 7) corresponds to a cross-sectional view taken along the line B-B in FIG. 2. In these cross-sectional views, the internal structures of the display unit 10 and the body unit 15 are not illustrated, and these entire cross-sections are hatched.

As illustrated in FIGS. 2 to 7, the slide mechanism, including a slide guide 20 or the like, is provided between the display unit 10 and the body unit 15 of the portable device 1. In addition, the cable 35 (see FIG. 8) for electrically connecting between the display unit 10 and the body unit 15 is also provided between the display unit 10 and the body unit 15.

The structure of the slide mechanism (hereinafter, also indicated as slide mechanism according to the embodiment) used in the portable device 1 will be described.

As illustrated in FIG. 2, the slide mechanism according to the embodiment includes the slide guide 20, a pair of slide rails 25 and 26, and the torsion spring 30.

The slide guide 20 is a rectangular cylindrical member with a bottom, in which a flange 20a is provided on its outer peripheral surface. It is noted that the flange 20a provided in the slide guide 20 has the substantially same projecting amount (projecting length) from each side thereof.

The slide guide 20 is fixed in an area (hereinafter, indicated as non-exposed area), on an operation surface of the body unit 15, where no operation key is arranged, in a state (orientation) where each side of the slide guide 20 is substantially parallel to each side of the body unit 15.

In one sidewall of the slide guide 20, a ball plunger 21 is buried such that its end side (ball side) is exposed on an upper surface of the slide guide 20.

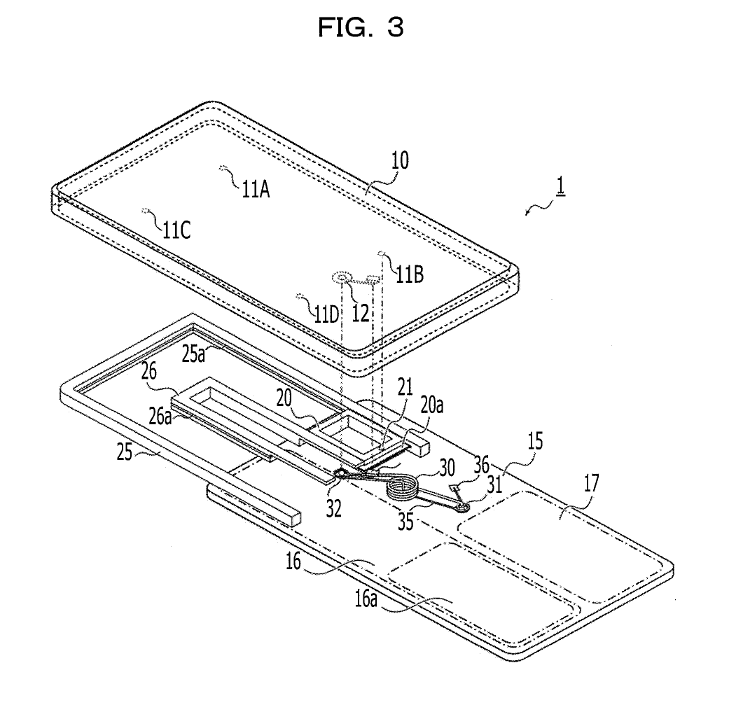

On a back surface of the display unit 10, ball receivers 11A to 11D are mounted. These ball receivers are for the ball plunger 21, and the ball receiver 11A is mounted on the back surface of the display unit 10 and at a position which is substantially directly above the ball plunger 21 when the portable device 1 is in the mode A. In addition, the ball receivers 11B to 11D are mounted on the back surface of the display unit 10 and at positions (see FIGS. 3 to 5), which are substantially directly above the ball plunger 21 when the portable device 1 are in the modes B to D, respectively.

The slide rail 25 (see FIGS. 2, 6, and 7) is a substantially U-shaped member, which is thinner than the slide guide 20. On an inner surface of the slide rail 25, a groove 25a is provided so as to be parallel to an upper surface of the slide rail 25 and has a size for allowing the flange 20a to be fitted therein. The groove 25a is provided at such a position that, when the flange 20a is fitted thereto, the upper surface of the slide guide 20 is slightly lower in height than the upper surface of the slide rail 25.

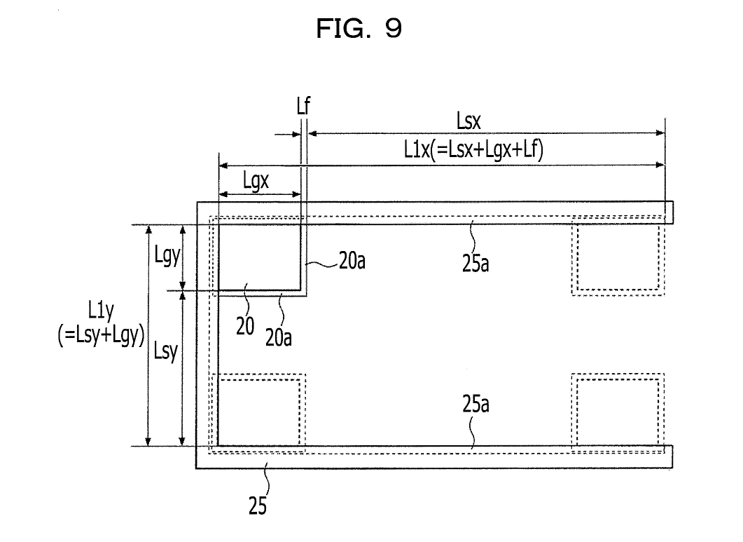

In reference to FIG. 9, the structure (shape) of the slide rail 25 will be described more specifically below. Hereinafter, two mutually parallel columnar portions (portions corresponding to side bars of the substantially U-shape) of the slide rail 25 are indicated as arm portions, and the remaining portion (a portion connecting the two arm portions) of the slide rail 25 is indicated as a connection portion. In addition, a necessary slide amount of the display unit 10 in the X direction (right-left direction) (=length of function key part 17 in right-left direction+α) and a necessary slide amount of the display unit 10 in the Y direction (front-rear direction) (=length of full key part 16+α′) are indicated as X direction slide amount Lsx and Y direction slide amount Lsy, respectively. Further, lengths of a body portion of the slide guide 20 (a portion other than the flange 20a) in the X direction and the Y direction are indicated as Lgx and Lgy; and the projecting amount of the flange 20a from the body portion of the slide guide 20 is indicated as Lf.

As already described, the slide rail 25 is a member in which the groove 25a is provided on its inner surface, but the groove 25a does not extend to an end of each arm portion as illustrated in FIG. 9 (and FIGS. 2 to 6). The slide rail 25 is formed such that a length L1x of the groove 25a on the inner surface of each arm portion is “Lsx+Lgx+Lf” and an interval L1y between the inner surfaces of both arm portions is “Lsy+Lgy”.

In other words, the slide rail 25 is a member having a shape which is determined such that its maximum movement amount in the up-down direction in a state where the slide rail 25 engages with the slide guide 20 substantially agrees with its front-rear direction slide amount Lsy (such that it is satisfied that L1y−Lgy=Lsy. It is noted that the state where the slide rail 25 engages with the slide guide 20 is a state where the flange 20a of the slide guide 20 is inserted in the groove 25a (a state where side surfaces of the body portion of the slide guide 20 are in contact with the inner surface of the slide rail 25).

In addition, the slide rail 25 is also a member having a shape which is determined such that its maximum movement amount in the right-left direction in a state where the slide rail 25 engages with the slide guide 20 substantially agrees with its X direction slide amount Lsx (such that it is satisfied that L1x−Lgx−Lf=Lsx.

The slide rail 26 (see FIGS. 2 and 7) is a substantially U-shaped member which has the substantially same thickness as that of the slide rail 25 and is smaller than the slide rail 25. Hereinafter, portions of the slide rail 26 are indicated as arm portions, and a connection portion, similarly to each portion of the slide rail 25.

On an outer surface of the slide rail 26 (an outer surface of each arm portion and an outer surface of the connection portion), a groove 26a corresponding to the groove 25a of the slide rail 25 is provided. Specifically, the groove 26a is provided on the outer surface of the slide rail 26 such that, when the flange 20a is fitted therein, the upper surface of the slide guide 20 is slightly lower in height than an upper surface of the slide rail 26.

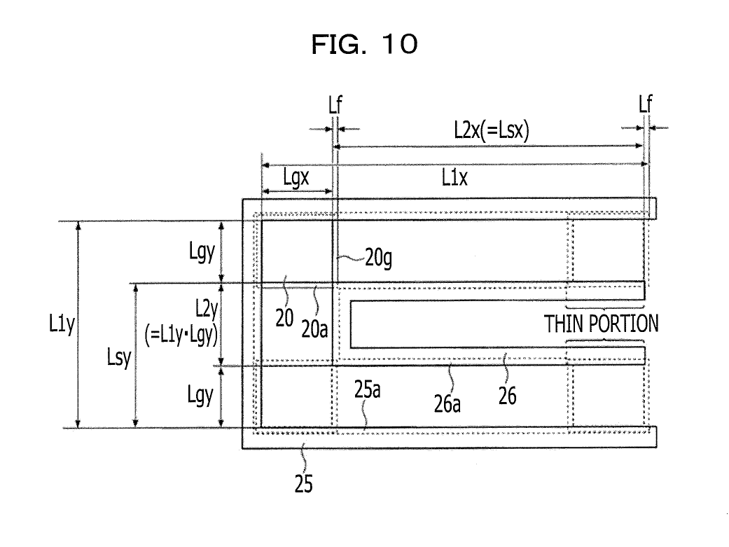

As illustrated in FIG. 10, the slide rail 26 is formed such that its length L2y in the Y direction is “L1y−2*Lgy” (=Lsy−Lgy) and its length L2x in the X direction is Lsx. In other words, the slide rail 26 is a member having a shape which is determined such that a space which allows the slide guide 20 to move only along the inner surface of the slide rail 25 (the outer surface of the slide rail 26) can be formed by the slide rail 26 being combined with the slide rail 25.

Further, in order to secure a space for accommodating a coil portion of the torsion spring 30 (details to be described later), each arm portion of the slide rail 26 is provided, at and near a distal end thereof, with a portion having a lower part removed (a portion having a part near the upper surface being the only part remaining; hereinafter, indicated as thin portion). Specifically, at a part of each arm portion of the slide rail 26 (see FIGS. 3 and 7) which has a length of about Lgx from the distal end of the arm portion, the thin portion is provided which has such a thickness that the thin portion contacts only a part of the side surface of the slide guide 20 which is above the flange 20a.

The slide rails 25 and 26 are members having the above structures and shapes, and are also members which are fixed on the back surface of the display unit 10 in a state where the slide guide 20 is interposed between these members (see FIGS. 2 and 6).

The torsion spring 30 (FIG. 2) is a torsion coil spring in which distal end portions (hereinafter, indicated as end portions) of arms are bent so as to be parallel to the axis of the coil porting and so as to be directed in opposite directions.

In the non-exposed area of the body unit 15, a body side torsion spring holding part 31 (hereinafter, also indicated merely as holding part 31) for rotatably holding one end portion of the torsion spring 30, is fixed.

Further, on the back surface of the display unit 10, a display side torsion spring holding part 32 (hereinafter, also indicated merely as holding part 32) for rotatably holding the other end portion of the torsion spring 30, is fixed. It is noted that the holding part 32 is not previously fixed on the back surface of the display unit 10, but is fixed to a torsion spring connection part 12 on the back surface of the display unit 10 in a state where the holding part 32 is fitted onto one end portion of the torsion spring 30 (see FIG. 8), during final assembling of the portable device 1 (details thereof will be described later).

The fixed position of the holding part 31 on the operation surface of the body unit 15 and the fixed position of the holding part 32 on the back surface of the display unit 10 (that is, the position of the torsion spring connection part 12) are determined such that the interval therebetween becomes the minimum during a period when the mode of the portable device 1 is changed from a mode to a next mode. The torsion spring 30 is fixed at one end portion thereof to the body unit 15 through the holding part 31, and is fixed at the other end portion to the display unit 10 through the holding part 32 (namely, the torsion spring 30 is rotatably held at one end portion thereof by the body unit 15, and is held at the other end portion thereof by the display unit 10).

Next, a structure related to the cable 35 of the portable device 1 will be described with how to assemble the portable device 1.

In the portable device 1 according to the embodiment, the cable 35 is provided between the display unit 10 and the body unit 15 by using the above structure related to the torsion spring 30.

Specifically, as illustrated in FIG. 8, a body side cable lead-in part 36 and a display side cable lead-in part 37 are mounted at positions on the cable 35 such that a length of the cable 35 therebetween is of a predetermined length. It is noted that the predetermined length is a length which is previously determined on the basis of the size of the torsion spring 30 or the like such that a later-described cable layout (layout of the cable 35 as illustrated in FIG. 8) is possible.

The body side cable lead-in part 36 (hereinafter, indicated merely as lead-in part 36) mounted on the cable 35 is a member for fixing a part of the cable 35 (a portion where the lead-in part 36 is mounted) to the body unit 15 therethrough. At a predetermined position in the non-exposed area on the operation surface of the body unit 15 (a position near the fixed position of the holding part 31), a recess is provided so as to have a shape in which the lead-in part 36 is fitted.

The display side cable lead-in part 37 (hereinafter, indicated merely as lead-in part 37) is a member for fixing a part of the cable 35 to the display unit 10 therethrough. At a predetermined position on the back surface of the display unit 10 (a position near the torsion spring connection part 12; see FIG. 2 or the like), a recess is provided so as to have a shape in which the lead-in part 37 is fitted. Specifically, in a lower portion of the housing of the display unit 10 (a portion which forms the back surface of the display unit 10; hereinafter, indicated as lower housing), the recess is provided so as to have the shape in which the lead-in part 37 is fitted. It is noted that the recess provided in the lower housing of the display unit 10 and the recess provided in the operation surface of the body unit 15, as described above, each has a through hole for passing the cable 35 therethrough.

During assembling of the portable device 1, an operation is conducted, in which a cable assembly having a structure as illustrated in FIG. 8 is assembled on the operation surface of the body unit 15. This operation (hereinafter, indicated as cable assembly assembling operation) can be conducted in various procedures. Hereinafter, the contents of the cable assembly assembling operation will be described with, as an example, a case where the holding part 31 and the slide guide 20 are first fixed to the body unit 15.

In the cable assembly assembling operation in the case where the holding part 31 (and the slide guide 20) has already been fixed to the body unit 15, first, an operation is conducted, in which the lead-in part 36 is mounted in the recess on the operation surface of the body unit 15 in a state where the end of the cable 35 on the lead-in part 36 side is inserted in the body unit 15. In addition, an operation for mounting the holding part 32 to one end portion of the torsion spring 30, and an operation for mounting the other end portion of the torsion spring 30 to the holding part 31 fixed to the body unit 15, are conducted.

After these operations, an operation, in which the end of the cable 35 on the lead-in part 37 side is wound around the holding part 31, passed through inside the coil portion of the torsion spring 30, and wound around the holding part 32, is conducted, thereby assembling the cable assembly.

After the cable assembly is assembled, an operation for arranging the slide rails 25 and 26 on the operation surface of the body unit 15 so as to have the positional relationship with the fixed slide guide 20 as illustrated in FIG. 2 (also see FIGS. 3 to 5) is conducted.

Thereafter, an operation for covering the body unit 15, in which the slide rails 25 and 26 and the slide guide 20 have been arranged/fixed, with the lower housing of the display unit 10 is conducted. Then, an operation of fixing the slide rails 25 and 26 and the lead-in part 36 to the lower housing with which the body unit 15 has been covered, an operation of connecting the cable 35 to devices in the display unit 10/body unit 15 or the like, are conducted, thereby assembling the portable device 1.

As described in detail above, the portable device 1 according to the embodiment is a device which uses the slide mechanism including the slide guide 20 and the pair of substantially U-shaped slide rails 25 and 26, in order to allow the display unit 10 to slide in two directions.

The slide mechanism can be implemented (manufactured) with a thickness which is nearly the same as that of a slide mechanism which allows the display unit 10 to slide only in a certain direction (hereinafter, indicated as single direction slide mechanism). In order to allow the display unit 10 to slide in two directions by using single direction slide mechanism, two single direction slide mechanisms have to be stacked on each other. In addition, in this case, even when parts are shared, the thickness cannot be nearly the same as that of one single direction slide mechanism. Thus, the slide mechanism according to this embodiment can implement a portable device, which allows the display unit 10 to slide in two directions and is thinner than an existing one.

Further, the slide mechanism according to this embodiment includes: the ball plunger 21 which is fixed to the slide guide 20; and the ball receivers 11A and 11C which are fixed on the back surface of the display unit 10 and at positions which are located directly above the ball plunger 21 when the portable device 1 is in the modes A and C, respectively. Thus, the slide mechanism according to the embodiment dose not cause problems which are caused by a slide mechanism which consists of only the slide rails 25 and 26 and the slide guide 20.

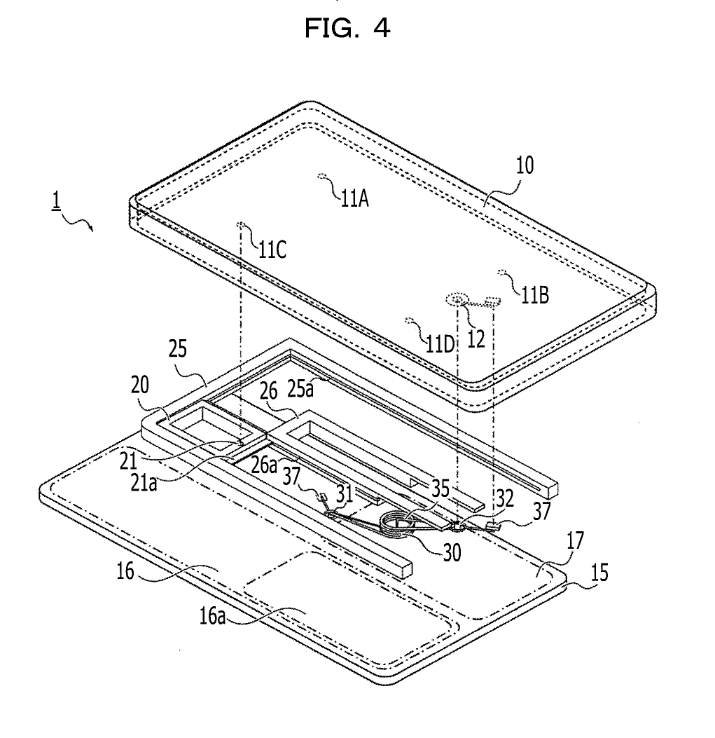

Specifically, when the portable device 1 is in the mode A or C (see FIGS. 2 and 4), the slide mechanism which uses the substantially U-shaped slide rails 25 and 26 is in a state where the slide guide 20 is not interposed between the slide rails 25 and 26 (that is, in a state where the slide guide 20 is allowed to rotate to some extent relative to the slide rails 25 and 26). Thus, when the slide mechanism which consists of only the slide rails 25 and 26 the slide guide 20 is used, a problem occurs that in the mode A or C, the display unit 10 becomes loose.

On the other hand, in the case where the slide mechanism having the above structure is used, when the portable device 1 is in the mode A or C, the ball plunger 21 engages with the ball receiver 11A or 11C, thereby preventing the slide guide 20 from rotating relative to the slide rails 25 and 26. Thus, the slide mechanism according to this embodiment does not cause the above problem.

Further, the slide mechanism according to the embodiment also includes the ball receivers 11B and 11D which are fixed on the back surface of the display unit 10 and at positions which are located directly above the ball plunger 21 when the portable device 1 is in the modes B and D, respectively. Engagement of the ball plunger 21 with the ball receiver 11X (X=A, B, C, or D) is recognized by a change of hand feeling or a sound. Thus, the portable device 1 is a device which can prevent a wasteful operation which reduces the life of the device (an operation for attempting to cause the display unit 10, which is in a state where the display unit 10 cannot be slid in a certain direction any further, to slide in this direction) from being performed.

Further, the slide mechanism according to this embodiment includes the torsion spring 30 having end portions which are rotatably held by the display unit 10 and the body unit 15, respectively. The positions of the end portions of the torsion spring 30 are determined such that the distance between the end portions becomes the minimum, while the mode of the portable device 1 is changed. Thus, the slide mechanism according to this embodiment has a function for applying, between the display unit 10 and the body unit 15, a force in such a direction as to assist a slide operation of the display unit 10. Moreover, the portable device 1 which uses this slide mechanism is a device which can be easily in each mode (a device in which it is unnecessary to actually cause the display unit 10 to slide, until the device comes into an intended mode).

It is noted that, when the portable device 1 is in the mode A or C, the torsion spring 30 presses the slide guide 20 against the inner surface of the connection portion of the slide rail 25 (pulls the connection portion of the slide rail 25 toward the slide guide 20). Thus, in the slide mechanism according to the embodiment, rotation of the slide rails 25 and 26 around the slide guide 20 is prevented by the torsion spring 30 as well.

Further, in order that the distance between the end portions of the torsion spring 30 becomes the minimum while the mode of the portable device 1 is changed, a part (normally, the coil portion) of the torsion spring 30 has to be located below the slide rail 26. However, in the slide mechanism according to the embodiment, a space for accommodating the torsion spring 30 is secured below the slide rail 26, by providing the thin portion in each arm portion of the slide rail 26 (by thinning the distal end side of each arm portion of the slide rail 26). Thus, the slide mechanism according to the embodiment is a mechanism in which a thickness increase caused by incorporating the torsion spring 30 therein is extremely small.

Moreover, the cable 35 for electrically connecting between the display unit 10 and the body unit 15 of the portable device 1 is arranged along the torsion spring 30 or the like (see FIG. 8). Thus, in the portable device 1, a problem related to the cable 35 does not occur even when the portable device 1 has been used for a long period of time.

Specifically, as seen from FIGS. 2 to 5, in the portable device 1, by a slide operation of the display unit 10, the positional relationship (distance and angle) between the fixed position of the cable 35 on the display unit 10 side and the fixed position of the cable 35 on the body unit 15 side, relatively speaking, greatly changes.

Thus, in the case of connecting between the display unit 10 and the body unit 15 of the portable device 1 simply by the cable 35, when the interval between both fixed positions is small, it is thought that the cable 35 is bent toward the slide rail 26 (or 25) and caught on the slide rail 26 (or 25). In addition, each time a slide operation is performed (each time the angle between both fixed positions is changed), it is also thought that the cable 35 is twisted at a specific position, resulting in breakage of the cable 35.

Meanwhile, if the cable 35 is arranged as described above, the shape of the cable 35 when the interval between both fixed positions is small can be limited to one in which the cable 35 passes through near the holding part 31, inside the coil portion of the torsion spring 30, and near the holding part 32. Thus, the cable 35 can be prevented from being bent toward the slide rail 26 (or 25) and caught on the slide rail 26 (or 25). In addition, any twist of the cable 35 is absorbed by the looped portion of the cable 35 around the holding part 31 and the looped portion of the cable 35 around the holding part 32, and thus breakage of the cable 35 caused by twist can be prevented.

Further, the portable device 1 uses the structure in which the cable 35 is fixed to the body unit 15 and the display unit 10 by the lead-in parts 36 and 37. Thus, the portable device 1 is easily caused to be waterproof (prevent water from entering the body unit 15 and the display unit 10).

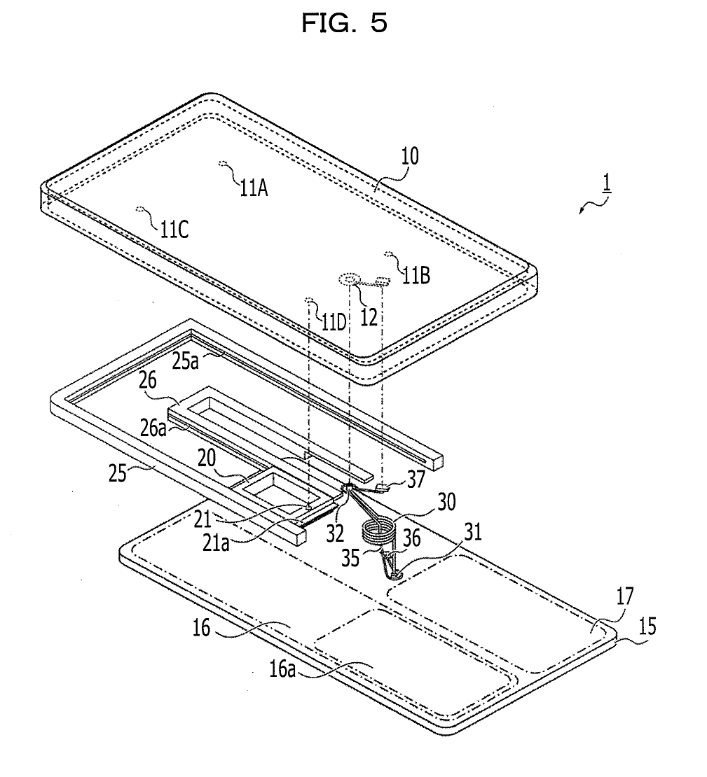

In addition to the modes B and C, the portable device 1 can be in the mode D (see FIGS. 1 and 5) which allows the full key part 16 and the function key part 17 (namely, all the operation keys on the operation surface) to be used.

Therefore, the portable device 1 according to the embodiment is a device with which various functions are easily used (a mode suitable for a function to be used can be selected from the modes B to C and the function can be operated). In addition, with the structure used in the portable device 1, functions which are easily operated when all the keys are exposed are easily implemented.

Various modifications can be made to the above portable device 1. For example, the portable device 1 can be modified into one in which the slide guide 20 in which the flange 20a is provided at the upper surface (the slide guide 20 in which the upper surface of the flange 20a is level with the upper surface of the body portion) is used. It is noted that, when such a slide guide 20 is used, the contact area between the entire upper surface of the slide guide 20 and the back surface of the display unit 10 is increased, resulting in an increase of a force required for a slide operation. Thus, as the slide guide 20, it is desirable to use one having the above shape.

Further, as the slide rail 26, one having a length in the right-left direction shorter than that of the above one can be used. It is noted that, if the length of the slide rail 26 is excessively short, when the positional relationship between the slide guide 20 and the slide rails 25 and 26 is as illustrated in FIG. 3 or 5, the slide guide 20 disengages from the slide rail 25 (or rotates). Thus, the slide rail 26 should be long enough to prevent occurrence of this.

Moreover, it is understood that a leaf spring or the like may be used instead of the torsion spring 30 and some of the components of the portable device 1 (e.g., the ball receivers 11B and 11D, the ball plunger 21, and the ball receivers 11A to 11D) may be removed.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments in accordance with aspects of the present inventions have been described in detail, it should be understood that various changes, substitutions, and alterations could be made hereto without departing from the spirit and scope of the invention.

What is claimed is:

1. A portable device, comprising:
a body unit which includes an operation surface on which a plurality of operation keys are provided;
a display unit which includes a display surface on which an image display element is provided;
a pair of substantially U-shaped slide rails which are fixed to a back surface of the display unit which is opposite to the display surface; and
a slide guide which is fixed to the operation surface of the body unit and slidably engages with the pair of substantially U-shaped slide rails.

2. The portable device according to claim 1, further comprising:
a ball plunger which is mounted to the slide guide and whose distal end side faces the back surface of the display unit; and
ball receivers each of which is provided on the back surface of the display unit and at a position which faces the ball plunger when the slide guide is located at each position where the slide guide is slidable between the pair of substantially U-shaped slide rails in two directions perpendicular to each other.

3. The portable device according to claim 2, further comprising: ball receivers each of which is provided on the back surface of the display unit and at a position which faces the ball plunger when the slide guide is located at each position which is defined as an end point position on an open end side between the pair of substantially U-shaped slide rails.

4. The portable device according to claim 1, further comprising: a spring member, which is mounted at one end thereof to the operation surface of the body unit, being mounted at another end thereof to the back surface of the display unit, and assisting a slide operation on the body unit of the display unit.

5. The portable device according to claim 1, further comprising:
a torsion spring in which end portions of feet thereof are bent so as to be parallel to an axis of a spring portion and so as to be directed in opposite directions;
a body unit side spring holding part, which is provided on the operation surface of the body unit and rotatably holds the end portion of one foot of the torsion spring;
a display unit side spring holding part, which is provided on the back surface of the display unit and rotatably holds the end portion of the other foot of the torsion spring; and
a cable, which is provided so as to pass through inside the spring portion of the torsion spring and so as to loop around the end portion of each foot of the torsion spring and electrically connects an electronic circuit in the body unit to an electronic circuit in the display unit.

6. The portable device according to claim 4, wherein
the spring member is a torsion spring.

7. The portable device according to claim 1, wherein:
the slide guide is a rectangular plate-like member having a flange which extends around side surfaces thereof,
one of the pair of substantially U-shaped slide rails is a first substantially U-shaped slide rail having, on an inner surface thereof, a groove which is fitted to the flange of the slide guide, and
the other of the pair of substantially U-shaped slide rails is a second substantially U-shaped slide rail having, on an outside thereof, a groove which is fitted to the flange of the slide guide.

8. The portable device according to claim 7, wherein
the second substantially U-shaped slide rail has a shape in which a surface thereof facing the back surface of the display unit is flat and each distal end is thinner than the other portion.
